(19) United States
(12) Patent Application Publication
(10) Pub. No.: US 2012/0116744 A1
(43) Pub. Date: May 10, 2012

(54) Method for Designing a Process Controller

(75) Inventor: Bernd-Markus Pfeiffer, Worth (DE)

(73) Assignee: Siemens Aktiengesellschaft, Muenchen (DE)

(21) Appl. No.: 13/252,633

(22) Filed: Oct. 4, 2011

(30) Foreign Application Priority Data
Oct. 5, 2010 (EP) EP10186612

(51) Int. Cl. G06F 17/50

(52) U.S. Cl. 703/13

(57) ABSTRACT

A method for designing a process controller for a process variable comprising a pressure or a flow rate, which is connectable upstream in a closed control loop of a controlled system having a positioning drive, where the closed control loop is simulated to determine the performance of the process controller. A predetermined noise value is added to a simulated profile of the actual value of a process variable, where the predetermined noise value is preferably obtained by performing a measurement at a real positioning drive. The simulated profile of the manipulated variable of the process controller is evaluated to determine an estimated energy consumption of the drive. As a result, it is thereby possible to find a compromise between the controller performance when setting the process controller without needing a direct measurement of the energy consumption at a real drive.

### BACKGROUND OF THE INVENTION

1. Field of the Invention

The invention relates to control systems and, more particularly, to a method for designing a process controller for a process variable comprising a pressure or a flow rate, which is connectable upstream in a closed control loop of a controlled system that includes a positioning drive.

2. Description of the Related Art

In practice, many proportional-integral-derivative (PID) controllers are set by more or less systematic sampling and/or, at best, by heuristic setting rules, where a “D” component of a PID controller is frequently not used at all. However, it is very time-consuming to optimize a PID controller by sampling alone.

It is for this reason that increasing use is being made of computer assisted methods for designing process controllers, such as by use of a PID tuner, which is integrated in the engineering system of a conventional SIMATIC PCS 7 process control system. The determination of advantageous controller parameters which, in addition to the selection of a suitable controller type constitutes an important step in controller design, can be performed by a procedure in which the first step comprises forming a model of the controlled system by using the appropriate software tool of the PID tuner for controller optimization. To this end, the process is excited either by a jump in a manipulated variable during manual operation of the controller, or by a setpoint jump in automatic operation if an approximate, at least stable controller design is already present. The measured data thereby determined are used to identify a dynamic process model, i.e., the structure and parameters of a process model are determined such that the measured data are optimally approximated by data of the process model. The determination of advantageous controller parameters of a PID controller are determined based on the identified process model, for example, by using the method of the absolute value optimum. In order to assess the performance of the controller thus obtained, the closed control loop can be simulated with the aid of the controller that is obtained. The profiles of the system deviation or the actual value of the control loop thereby obtained are output on a graphical user interface (GUI) such that a visual assessment can be performed, for example, a visual assessment of the disturbance response or of the command response. In addition, various controller types and parameterizations of the controller for performing renewed simulation calculations are offered for the purpose of further optimization by the user. The controller design is concluded after selection of the most suitable setting of the controller.

DE 100 46 005 A1 discloses a further method for computer assisted design and for the commissioning of controllers.

In certain industrial plants, many control loops, i.e., flow rate and pressure control loops, use continuous valves as actuators that are moved by an electro-pneumatic actuator, with or without underlying positioning control. If the actuator has an internal position control loop, what is involved is a cascade structure with the process controller (for example, pressure or flow rate controller) as command controller and the position controller, mostly integrated in the field device, as a slave controller. Pneumatic positioning drives have the advantage that they can be actuated comparatively quickly and can achieve high positioning forces. Furthermore, pneumatic positioning drives are mostly uncritical in the area of explosive environments, in outdoor use and at low temperatures. In industrial plants, however, compressed air is one of the most expensive energy sources, because the provision of compressed air with the aid of compressors has a poor level of efficiency, and because pressure losses and possible leaks occur in the extensively branched pneumatic pipeline networks. The consumption of compressed air by individual pneumatic drives, however, is not measured, because this would entail a comparatively high expenditure. In addition, in the case of many other drives, such as electric motor drives, a separate measurement point for direct acquisition of their energy consumption is mostly dispensed with, because this always involves a certain outlay. In every case, the energy consumption of the drives is clearly dependent on the setting of the respectively assigned process controller. For the above-described reasons, the level of energy consumption is in most cases not acquired by direct measurement. As a result, the direct measure of the consumption is frequently not taken into account in the design of the controller, and controller settings are obtained which, although they do satisfy the requirements with reference to disturbance and command responses, nevertheless often entail an unnecessarily high energy consumption of the drives.

### SUMMARY OF THE INVENTION

It is therefore an object of the invention to provide a method for designing a process controller upstream to which a positioning drive is connected, where the energy consumption of the positioning drive can be taken into account in addition to the performance of the controller with respect to disturbances and command responses.

These and other objects and advantages are achieved in accordance with the invention by providing a computer program, a computer program product and method in which a predetermined noise value of a process variable comprising the pressure or the flow rate, is advantageously used for estimating the energy consumption of the drive. Preferably, the noise corresponds to fluctuations in the actual value of the process variable in the stationary state, i.e., at a constant desired value and a terminated initial response. This stationary state corresponds to the most frequently occurring situation in an industrial plant. In the simulation of the closed control loop, it is advantageous to determine the reaction of the controller to this noise by adding the predetermined noise value to the simulated actual value or to the system deviation fed to the controller.

The technical data of positioning drives, or empirical tests can be used to determine the respective drive specific relationship between the position changes effected by the drive and the energy consumption respectively associated therewith. The profile of the manipulated variable, which corresponds in the case of a cascade structure to the profile of the desired position value given to the internal position control loop of the drive, is evaluated to determine an estimate of the energy consumption of the drive. As a result, it is therefore advantageously possible to dispense with the measurement of the power consumption of the drive that would be associated with a comparatively high outlay. Here, it is assumed that any position control loop that is possibly present within the field device is operating correctly so that the signal profile of the actual position value corresponds to the profile of the desired position value to a good approximation. Even the known PID tuner can be used to perform simulations of the closed control loop with various controller types, such as proportional (P), proportional-integral (PI) or PID controllers, and various controller parameters. The method in accordance with the invention can now be used in addition to the graphical display of the simulated signal profiles in the control loop to display an estimate for the energy consumption associated therewith. There is advantageously thus no further need in controller design to perform decisions whose lasting effects on the permanent energy consumption during operation of an industrial plant could not be estimated. However, the energy consumption is now taken into account in the controller design. The user can decide between various possible controller designs with the full knowledge of the associated costs caused by the estimated energy consumption.

In a particularly advantageous embodiment of the method in accordance with the invention, the noise value is predetermined by measuring the actual value profile of the process variable on a real controlled system with an underlying position control loop of the positioning drive in the stationary state. Such a noise value is a measure of disturbances and measurement noise in the control loop, and effects of the noise on the profile of the desired position value, i.e., in this case the manipulated variable, are realistically represented. Here, it is possible to use the deviation of the real measured actual value from the mean value.

In an advantageous embodiment, in the simulation the profile of the desired position value is evaluated in addition to the determination of an estimate for the wear of the drive. It is possible to additionally take into account the effects of the controller setting on the drive lifetime thereby when designing PID controllers. The user can therefore also make rational choices between various possible controller designs with the aid of the forecast valve lifetime.

A software tool for optimizing the control loop is preferably fashioned such that two or more different controller settings can be directly compared with one another on, for example, a graphical display, specifically both with regard to the signal profile for the purpose of assessing disturbance and command responses, and with regard to the energy consumption to be expected. To this end, the closed control loop is simulated for a plurality of different controller settings, and the estimates thereby determined for the energy consumption are output visibly for a user on a display.

As an alternative thereto, the energy consumption can, of course, be taken into account in a suitably defined performance index in the case of an automatic controller design, without the need for additional interventions by a user.

The method in accordance with the disclosed embodiments can be used with particular advantage in the case of a pneumatic drive for a control valve, where the mechanical power to be expended for the profile of the desired position value is calculated to determine the estimate of the energy consumption. The possibility to function without a direct measurement of the energy consumption of the drive is particularly significant here, because the compressed air consumption of the pneumatic drive would otherwise be acquired only with a comparatively high outlay.

In another embodiment, the estimate of the energy consumption is determined by combining the calculated mechanical power with a predetermined efficiency of the pneumatic drive and of the previously known efficiency of an electric compressor for producing compressed air has the advantage that the various losses in the chain of energy conversion are also taken into account, and a further improved controller design is thereby attained.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and its advantages and refinements are explained below in greater detail of an exemplary embodiment of the invention with the aid of the drawings, in which:

FIG. 1 shows a functional block diagram of a simulation model;

FIG. 2 shows a pneumatic valve with an upstream position controller; and

FIG. 3 is a flow chart of a method in accordance with an embodiment of the invention.

### DETAILED DESCRIPTION OF THE PREFERRED EMBODIMENTS

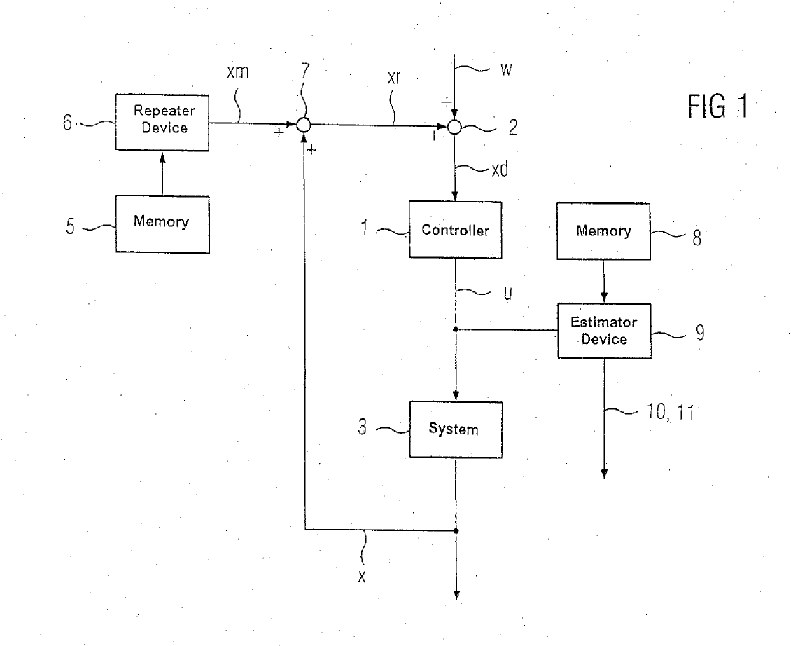

In the course of the computer aided design of a process controller 1, a computer program that runs, for example, on a processor in a personal computer, simulates the closed control loop, whose principle function blocks are illustrated in FIG. 1. Here it is also possible to use a convention proportional-integral-derivative (PID) tuner to simulate a control loop comprising a comparator device 2, the controller 1 and the system 3. The comparator device 2 is used to calculate from a prescribable desired value w and an actual value x, calculated at the output of the system 3 by simulation, a system deviation xd that is fed to the input of the controller 1. Depending on the calculated profile of the system deviation xd, the controller 1 determines a suitable profile of a manipulated variable u for the controlled system 3. For example, the performance of the controller 1 with reference to command responses can be evaluated by applying a step function as a profile of the desired value w with the aid of the profile thereby set for the actual value x. The performance of the controller 1 is checked by simulating the closed control loop before a newly designed controller is placed into use in an industrial plant.

In order for the model of the controlled system 3 that is used for simulation to optimally correspond with the real process, learning data of the real process that are used for process identification are additionally provided in the tuning tool, such as the PID tuner.

The simulation of the closed control loop is thus extended by an estimate of the energy consumption of a positioning drive that is a component of the controlled system 3. Because of the outlay associated therewith, it is usually impossible, in industrial plants, to make a direct measurement of the energy consumption of positioning drives, which can be driven by electric motor, hydraulically or, in particular, pneumatically. The estimation of the energy consumption as early as during the simulation of the control loop now makes it possible when setting the controller to find a reasonable compromise between controller performance with reference to disturbance and/or command response(s) and the energy consumption of the positioning drive.

A deviation xm of the real measured actual value from the mean value in the stationary state is a measure of disturbances and measurement noise in the real control loop. For the simulation, a representative time slot of a profile of these deviations xm is acquired as additional learning data of the real process and stored in a memory 5. A repeater device 6 is used to cyclically repeat this representative time slot for the simulation and is provided to an adder 7, where the representative time slot of the profile of the deviations xm is added to the simulated actual value x to form a noisy actual value xr. The system deviation xd is subsequently calculated as a difference between the desired value w and the noisy actual value xr. Superposing the predetermined noise xm onto the simulated actual value x of the process variable advantageously yields a simulation result that also realistically represents the effects of the noise xm on the profile of the manipulated variable u, which in the case of a cascade structure corresponds to the profile of the desired position value given to the internal position control loop of the drive.

It is possible, as an alternative to the exemplary embodiment described, for the location of the additive superposition to be a different, equivalent point, for example, downstream of the comparator device 2, such that values of the deviations xm are added on, as predetermined noise values, to values of the system deviation xd.

Characteristic data of the positioning drive are stored as further learning data in a memory 8, where the characteristic data are a component of the controlled system 3, and the characteristic data is, for example, derived with the aid of the technical data of the drive, or is determined by measurements on a comparable positioning drive. These characteristic data are used in an estimator device 9 to calculate an estimate 10 for the energy consumption of the positioning drive that is effected by the profile of the simulated manipulated variable u.

In a tuning tool that is implemented by a computer program running on a computer, it is possible to perform simulations with the aid of various controller types, for example, PID, proportional-integral (PI) or proportional (P) controllers, and various controller parameters. In addition to graphical display of the simulated profiles of the signals present in the control loop, which display is particularly helpful for assessing disturbance and command responses by a user, the estimate 10 of the energy consumption is displayed as a further variable for assessing the performance of the controller 1. The tuning tool can advantageously be configured such that two different controller settings can be directly compared with one another, specifically both with regard to the signal profiles and with regard to the respective energy consumption. The profiles of the simulated manipulated variable u that are evaluated for the calculation of the estimate 10 of the energy consumption can also advantageously be used to estimate the service life 11 of the positioning drive as a function of the PID controller setting. The wear of the positioning drive can thereby be taken into account as a further criterion in designing the PID controller.

The novel tuning tool thus enables an estimate of the energy consumption in the context of the simulations that are carried out in any case when a computer assisted controller is commissioned, and so it is possible to dispense with a complicated measurement of the energy consumption at individual positioning drives. Based on the estimated energy consumption and, if appropriate, the forecast service life of the positioning drive, the user can decide between various possible controller settings while being aware of the associated costs.

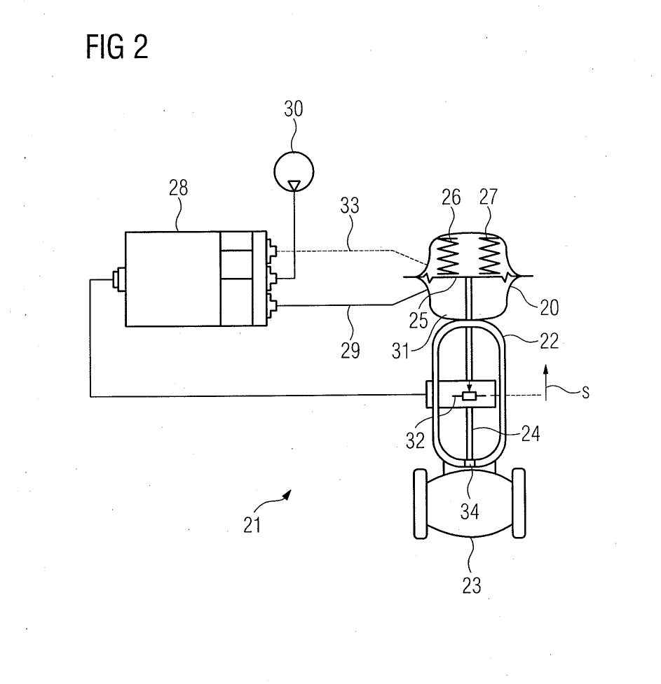

The disclosed embodiments of the method in accordance with the invention can be applied with particular advantage in a pneumatic drive 20 as a component of a control valve 21 whose design principle is illustrated in FIG. 2. The drive 20 is connected to a valve 23 via a yoke 22, and sets the positions of a closing element (not illustrated in detail in FIG. 2) in the valve 23 with the aid of a push rod 24. In the exemplary embodiment shown, a singularly acting drive 20, in the case of which there are arranged above a diaphragm 25 springs 26, 27 exerts a spring force on the diaphragm 25. A position controller 28 to which the manipulated variable u (FIG. 1) is supplied as a desired position value in a cascade structure switches compressed air delivered over a line 29 from a compressor 30 into the pressure chamber 31 located below the diaphragm 25, in order to set a position s detected with the aid of a position encoder 32 to a desired value.

In an embodiment that includes a double acting pneumatic drive, the springs 26, 27 would be omitted, and the position controller 28 would additionally be connected to an upper chamber of the pneumatic drive 20 by a line 33, which is drawn in with broken lines.

The mode of proceeding to estimate the energy consumption is explained in more detail below by way of example for the singularly acting pneumatic drive 20 shown in FIG. 2. Here, it is frequently the case in industrial plants that no cost effective and practical measurement is available for the compressed air consumption of individual pneumatic drives 20. Consequently, an estimate is made of the compressed air consumption with which movements of the push rod 24 by a path ds are associated. The starting point for the estimate is the required consumption of mechanical energy W for the movement of the push rod 24 along the path ds against a force F in accordance with the following relationship:

$$W = {\int }_{\vert \dot{s} \vert > 0} F ( s ) d s . \qquad Eq . 1$$

In the case of a singly acting drive 20, the valve is closed by spring force and opened by compressed air in the pressure chamber 31. Consequently, it is necessary to integrate only the path lengths that run counter to the direction of the spring force, i.e., |\dot{s}|>0. Here, it is necessary to perform work against the force of the springs 26, 27 which have, in sum, a spring constant D, and against a friction force F_{R}. It holds that:

F(s)=Ds+F₀+F_{R} Eq. 2

It is assumed in Eq. 2 that as early as in the closed state of the valve at s=0, the springs 26, 27 are pre-stressed by a force F₀ that serves to hold the valve 23 closed.

Here, the force that must be applied to accelerate the moving masses of the control valve 21 is neglected to a first approximation, because it is liberated again in the subsequent braking operation. Moreover, the weight of the closing element is neglected, because it is usually small in comparison to the spring force and depends on the location when the valve is installed. Retroactions of the fluid flowing through the valve 23 on the closing element can be predicted only poorly and are likewise neglected in the described estimate. The friction force F_{R} is produced largely in a packed gland seal 34 of the control valve 21 and is assumed to be constant and independent of speed to a first approximation. The mechanical energy W is therefore calculated in accordance with the relationship be:

$$\begin{matrix}W = {\int }_{\vert \dot{s} \vert > 0} ( Ds + {F}_{0} + {F}_{R} ) d s \\ = D {\int }_{\vert \dot{s} \vert \text{?} 0} s d s + ( {F}_{0} + {F}_{R} ) {\int }_{\vert \dot{s} \vert \text{?} 0} d s .\end{matrix} \\ \text{?} \text{indicates text missing or illegible when filed} \qquad Eq . 3$$

In the case of the simulation, the profile of the simulated manipulated variable u (FIG. 1), which prescribes the position s provided to a pneumatic control valve 21 in accordance with FIG. 2, is present as sampling values that are calculated for discrete instants. Here, the push rod 24, and thus the closing element in the valve 23 cover the path Δs in a sampling interval. Accordingly, the integration for calculating the estimate 10 (FIG. 1) is replaced by a summation in accordance with the following relationship:

$$W = D {\sum }_{Δ s > 0} s Δ s + ( {F}_{0} + {F}_{R} ) {\sum }_{Δ s > 0} Δ s . \qquad Eq . 4$$

After summing the mechanical work in a simulation time window of the predetermined length T, the average mechanical power P applied, i.e., the energy consumption, is obtained as a basis for decision in controller design in accordance with the relationship:

$$P = \frac{W}{T} \qquad Eq . 5$$

The evaluation of the profile of the simulated manipulated variable u (FIG. 1) for the purpose of determining an estimate for the energy consumption has been described in detail for a control valve 21 based on the example of a pneumatic drive 20 illustrated in FIG. 2. If, other than as in the case of the exemplary embodiment shown, the positioning drive involved is an electrically or hydraulically operated drive, or a doubly acting pneumatic drive, the above relationships depicted in the equations and the characteristic values used for estimation can immediately be replaced by suitable calculating methods in accordance with the physical circumstances prevailing there.

In cases in which the efficiency of the compressor 30 for the control valve 21 shown in FIG. 2 is known and that pressure losses or leaks in the pneumatic line of the industrial plant can be approximately estimated or neglected, the above determined estimate for the consumption of mechanical energy can additionally be converted to an electrical energy consumption for the operation of the compressor 30. In many cases, the costs associated with the energy consumption can be better compared in this way.

In order to assess the wear of the control valve 21 resulting in the case of the various controller settings, the sum of the paths As covered in the sampling intervals of a simulation run can be calculated in a simple way.

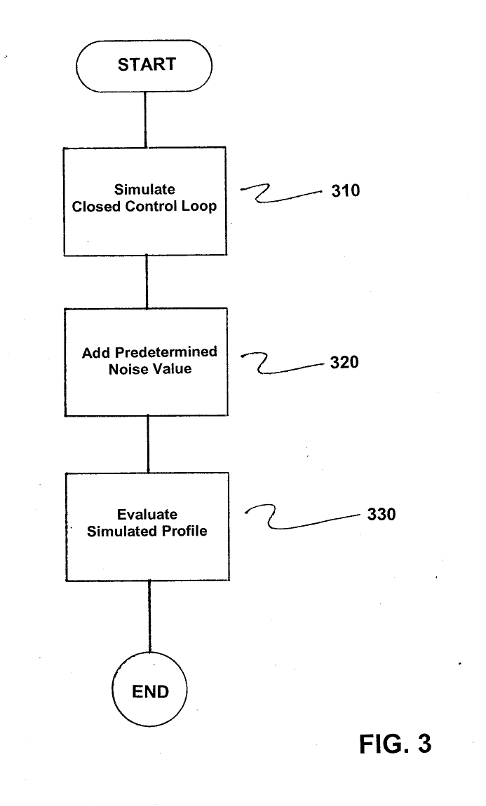

FIG. 3 is a flow chart of a method for designing a process controller for a process variable comprising a pressure or a flow rate which is connectable upstream in a closed control loop of a controlled system having a positioning drive. The method comprises simulating, by a processor of a computer, the closed control loop in relation to a simulated profile of one of an actual value of the process variable, a desired value and a system deviation to determine a performance of the process controller, as indicated in step 310.

A predetermined noise value is added, by the processor of the computer, to the simulated profile of the actual value of the process variable, as indicated in step 320. A simulated profile of a manipulated variable of the process controller is evaluated to determine an estimate of an energy consumption of the positioning drive, as indicated in step 330.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for designing a process controller for a process variable comprising a pressure or a flow rate which is connectable upstream in a closed control loop of a controlled system having a positioning drive, the method comprising:
simulating, by a processor of a computer, the closed control loop in relation to a simulated profile of one of an actual value of the process variable, a desired value and a system deviation to determine a performance of the process controller;
adding, by the processor of the computer, a predetermined noise value to the simulated profile of the actual value of the process variable; and
evaluating a simulated profile of a manipulated variable of the process controller to determine an estimate of an energy consumption of the positioning drive.

2. The method as claimed in claim 1, wherein the predetermined noise value is determined as a function of a measurement of the actual value of the process variable at a real positioning drive in a stationary state.

3. The method as claimed in claim 1, wherein simulation of the simulated profile of the manipulated variable of the process controller is evaluated to determine an estimate for wear of the positioning drive.

4. The method as claimed in claim 2, wherein simulation of the simulated profile of the manipulated variable of the process controller is evaluated to determine an estimation of wear of the positioning drive.

5. The method as claimed in claim 1, wherein the closed control loop is simulated for a plurality of different controller settings, and wherein estimates determined for the energy consumption are output visibly for a user on a display.

6. The method as claimed in claim 1, wherein the positioning drive is a pneumatic drive for a control valve, and wherein mechanical power to be expended for a profile of the manipulated variable is calculated to determine the estimate of the energy consumption.

7. The method as claimed in claim 6, wherein the estimate of the energy consumption is determined by combining a calculated mechanical power with a predetermined efficiency of the positioning drive and an electric compressor for producing compressed air.

8. A non-transitory computer program product comprising a storage medium encoded with a computer program executed by a computer that causes design of a process controller for a process variable comprising a pressure or a flow rate, which is correctable upstream in a closed control loop of a controlled system having a positioning drive, the computer program comprising:
program code for simulating, by a processor of a computer, the closed control loop in relation to a simulated profile of one of an actual value of the process variable, a desired value and a system deviation to determine a performance of the process controller;
program code for adding, by the processor of the computer, a predetermined noise value to the simulated profile of the actual value of the process variable; and
program code for evaluating a simulated profile of a manipulated variable of the process controller to determine an estimate of an energy consumption of the positioning drive.

9. A computer program executing on a processor which, when used on a computer, causes the processor to design a process controller for a process variable comprising a pressure or a flow rate, which is correctable upstream in a closed control loop of a controlled system having a positioning drive, the computer program comprising:
program code for simulating, by a processor of a computer, the closed control loop in relation to a simulated profile of one of an actual value of the process variable, a desired value and a system deviation to determine a performance of the process controller;
program code for adding, by the processor of the computer, a predetermined noise value to the simulated profile of the actual value of the process variable; and
program code for evaluating a simulated profile of a manipulated variable of the process controller to determine an estimate of an energy consumption of the positioning drive.
